(19) United States
(12) Patent Application Publication
(10) Pub. No.: US 2006/0236065 A1
(43) Pub. Date: Oct. 19, 2006

(54) Method and system for variable dynamic memory management

(76) Inventor: Woo Hyong Lee, Gyeonggi-do (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/369,946

(22) Filed: Mar. 8, 2006

(30) Foreign Application Priority Data
Apr. 13, 2005 (KR) 2005-30808

(51) Int. Cl. G06F 12/00

(52) U.S. Cl. 711/171

(57) ABSTRACT

Disclosed is a method and a related system for dynamic memory management utilizing both point-chasing and non-point-chasing schemes to allocate/de-allocate memory space in relation to a requested object's size.

### BACKGROUND OF THE INVENTION

1. Field of the Invention

Embodiments of the invention relate to a memory management method and a system incorporating same. More particularly, embodiments of the invention relate to a dynamic memory management method and a system incorporating same.

This application claims priority to Korean Patent Application 2005-30808 filed on Apr. 13, 2005, the subject matter of which is hereby incorporated by reference in its entirety.

2. Discussion of Related Art

Memory management capability is one important factor in the design and performance of an embedded system including a digital logic device, such as a microprocessor. In order to run various programs on a microprocessor within an embedded system, it is always necessary to allocate and de-allocate memory space within an associated memory. Memory allocation schemes may be classified into static memory allocation and dynamic memory allocation.

Static memory allocation techniques preemptively fix a unit allocation size within memory. Such techniques are useful in memory management operations acting on data of known or standard size(s). However, static memory allocation techniques can be very inefficient as variable (or random) data blocks are written into badly mismatched unit allocation blocks of fixed size. At a minimum, static memory allocation techniques inevitably waste memory space as the unit allocation size must be fixed at a size at least slightly larger than the maximum expected size of a data block.

In contrast, dynamic memory allocation is performed only when memory is actually needed during program execution. Only the amount of memory actually needed is allocated. Thus, dynamic memory allocation techniques have become widely used in conjunction with object-oriented programming techniques within contemporary embedded systems. In this regard, conventional object-oriented programming methods use dynamic memory allocation which not only allocates the required memory space, but also associates some additional information regarding the next object.

FIG. (FIG.) 1A is a schematic diagram showing a conventional method of dynamic point-chasing memory allocation in which allocation and de-allocation operations are associated with a linked sequence of objects. Upon receiving a first (e.g., a “root”) object to be stored, a related processor within an embedded system executing the object-oriented program allocates space within memory of sufficient size to store the first object. Thereafter, each subsequent object receives a memory space allocation in relation to the root object and any previously stored objects. This process is shown in FIG. 1A wherein the string of sequentially stored objects reference one another in a daisy chain manner is commonly referred as a point-chasing or linked list scheme.

Point-chasing schemes take advantage of the linked list data structure and the stored additional location information about the “next” object in the chain. That is, objects may be searched for within the linked list data structure using the additional location information. In order to do this, the search routine begins with the root object and sequentially traverses the linked list until it locates the desired object. This approach is very straight-forward in its application, but it can take a long time to find a desired object within a long linked list.

FIG. 1B is a schematic diagram showing a conventional method for dynamic memory de-allocation within a point-chasing scheme. For instance, if object 2 is removed from memory by some program execution step, a memory de-allocation request is made through the memory management system to de-allocate (e.g., return to the system for other use) the memory space previously used to store object 2. Object 2 must therefore be removed from the linked list, by functionally disconnecting objects 1 and 3 from object 2, and connecting object 1 to object 3 via a new link. This type of de-allocation scheme is lengthy and tends to stall execution of the overall program. At a minimum, this type of de-allocation scheme tends to increase power consumption by the embedded system which is particularly undesirable when the embedded system is intended for use in mobile, battery powered host devices.

### SUMMARY OF THE INVENTION

Embodiments of the invention provide a dynamic memory management method flexibly employing schemes for dynamic point-chasing memory allocation and dynamic non-point-chasing memory allocation, whereby objects may be stored in memory by an embedded system according to their actual size.

Thus, in one embodiment, the invention provides a method for dynamic memory management, comprising; upon receiving an allocation request in relation to a requested object, comparing a requested object size to a threshold value, allocating memory space using a point-chasing scheme when the requested object size is larger than the threshold value, else allocating memory space using a non-point-chasing scheme.

In another embodiment, the invention provides a method for dynamic memory management, comprising; upon receiving a de-allocation request in relation to a requested object, comparing a requested object size to a threshold value, de-allocating memory space using a point-chasing scheme when the requested object size is larger than the threshold value, else de-allocating memory space using a non-point-chasing scheme.

In yet another embodiment, the invention provides an embedded system comprising; an embedded processor adapted to control operation of the system, a subsidiary memory adapted to store program files defining operation of the system, and a main memory adapted to receive program files from the subsidiary memory, and further adapted to allocate memory space for a requested object using a dynamic point-chasing scheme or a non-point-chasing memory allocation scheme in accordance with the size of the requested object.

### BRIEF DESCRIPTION OF THE DRAWINGS

Several embodiments of the invention will be described with reference to the accompanying drawings. Like numerals refer to like or similar elements throughout the specification and drawings. In the drawings:

FIG. 1A is a schematic diagram showing a conventional method for dynamic point-chasing memory allocation;

FIG. 1B is a schematic diagram showing a conventional method for dynamic point-chasing memory deallocation;

FIG. 2 is a block diagram showing an embedded system;

FIG. 3 is a schematic diagram illustrating a method for dynamic non-point-chasing memory allocation by a preferred embodiment of the invention;

FIG. 4A is a schematic diagram illustrating a method for dynamic non-point-chasing memory de-allocation by a preferred embodiment of the invention;

FIG. 4B shows a free list of objects de-allocated in a block;

FIG. 5 is a flow chart illustrating a procedure by the method for variable dynamic memory allocation according to a preferred embodiment of the invention;

FIG. 6 is a flow chart illustrating a procedure by the method for variable dynamic memory de-allocation according to a preferred embodiment of the invention; and

FIG. 7 comparatively shows the performances by the dynamic memory allocation only with a point-chasing scheme and by the variable dynamic memory allocation alternatively operating the point-chasing and non-point-chasing schemes.

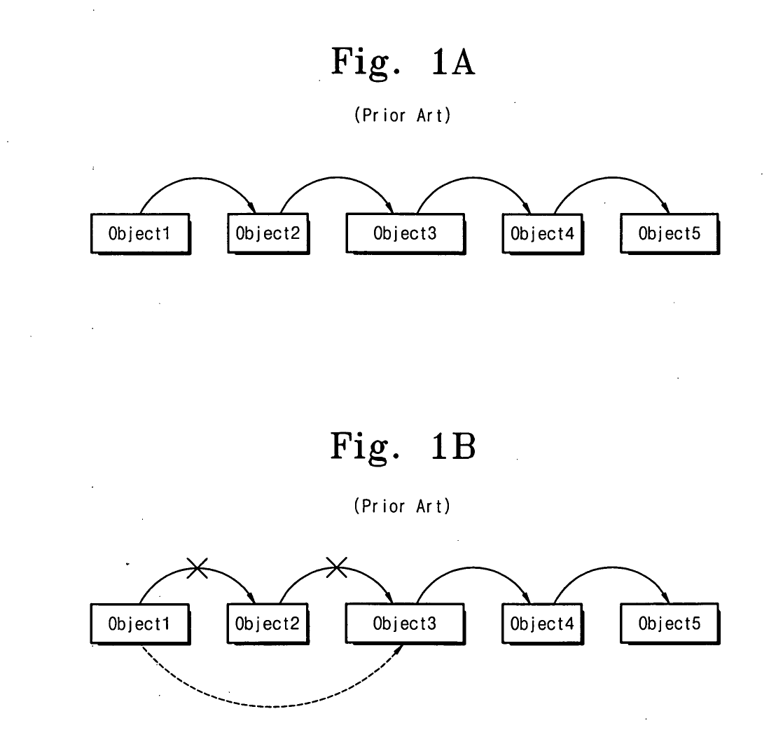

### DESCRIPTION OF EXEMPLARY EMBODIMENTS

Embodiments of the invention will be described in some additional detail with reference to the accompanying drawings. The present invention may, however, be embodied in many different forms and should not be constructed as being limited to only the embodiments set forth herein. Rather, these embodiments are provided as a teaching example.

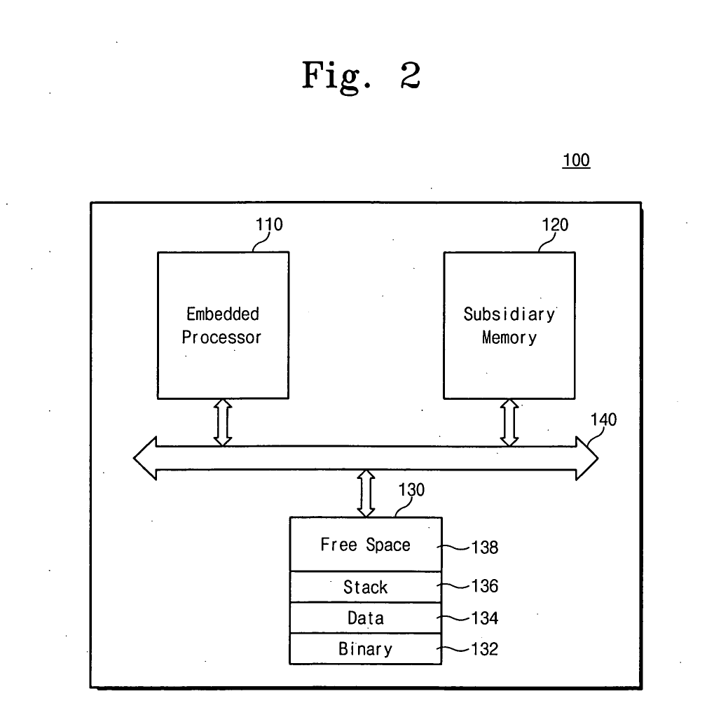

FIG. 2 is a block diagram showing an embedded system 100 generally comprising an embedded processor 110, a subsidiary memory 120, a main memory 130, and a bus 140.

Embedded processor 110 controls the overall operation of embedded system 100, including an associated operating system (OS) performing system house-keeping operations, such as scheduling tasks, managing communication between tasks, memory management, data input/output, program execution interrupts, etc.

Subsidiary memory 120 stores a program file that establishes an operational pattern for embedded system 100, and is typically formed by a read-only memory (ROM).

Main memory 130 stores the data (program-related and/or data object related) necessary for execution of embedded system operations. Upon initialization of embedded system 100 (e.g., power on), such data is typically loaded into main memory 130 from subsidiary memory 120. In the illustrated example, main memory 130 comprises a binary field 132 storing execution files included in the program data of subsidiary memory 120, a data field 134 storing global variables included in the program data of subsidiary memory 120, a stack 136 storing local variables included in the program data of subsidiary memory 120, and free space 138 to which objects associated with the program data of subsidiary memory 120 may be allocated and de-allocated.

Bus 140 is used as a transfer path for all of the foregoing data types within embedded system 100.

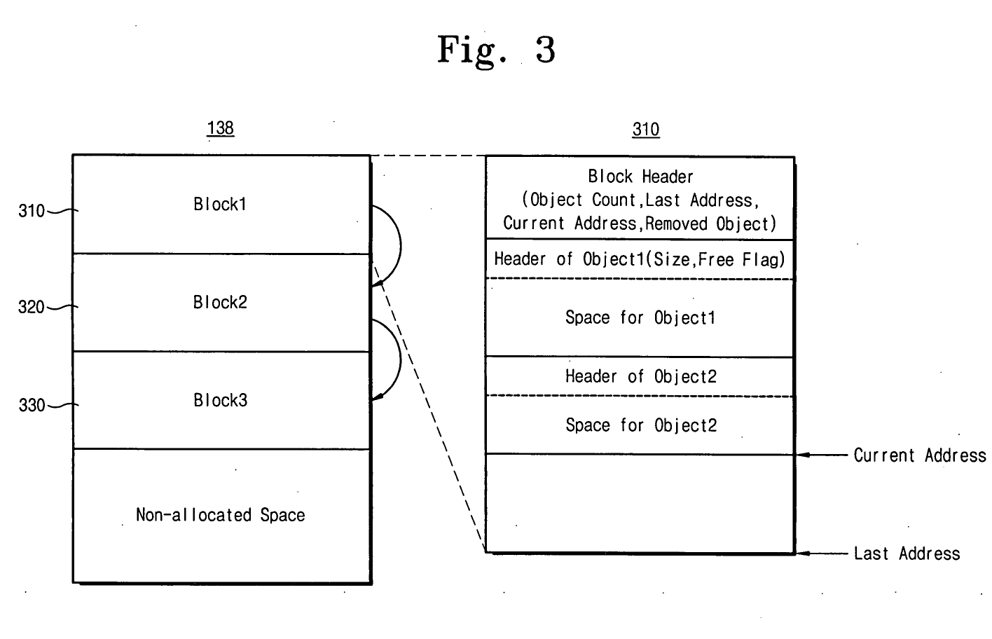

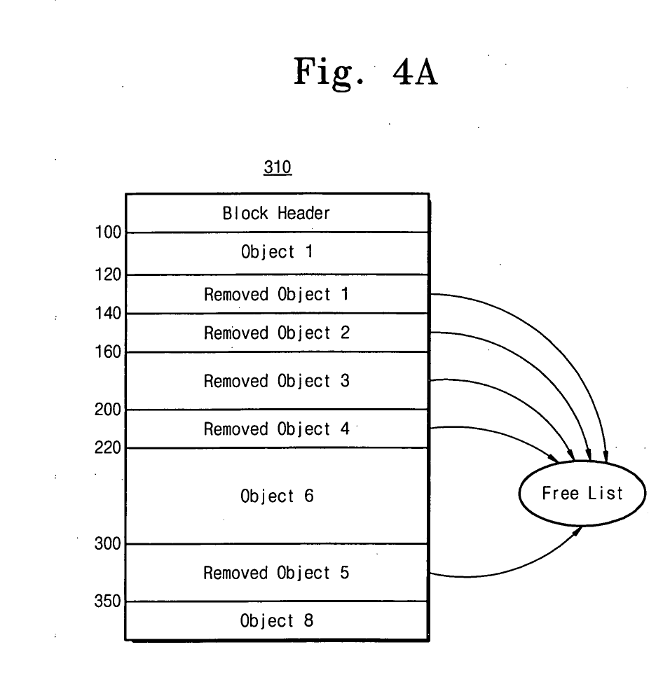

FIG. 3 is a schematic diagram illustrating a method of dynamic non-point-chasing memory allocation according to one embodiment of the invention. Execution of this exemplary method, and others that follow, will be described in the context of embedded system 100 shown in FIG. 2. However, these methods are also susceptible to execution by systems having various architectures.

During execution of a program routine, stored for example in binary field 132, and upon receiving a request to allocated memory space, embedded processor 110 compares the size of a “requested object” (i.e., the object to be stored) with a threshold value. The threshold value is used as a reference in making a determination to use a dynamic point-chasing memory allocation scheme or a dynamic non-point-chasing memory allocation scheme. If the size of a requested object is smaller than the threshold value, embedded processor 110 defines a first memory block (BLOCK1) having a predetermined size within free space 138. Embedded processor 110 then constructs a block header for BLOCK1 and allocates the defined memory to the first requested object (OBJECT1) in accordance with its size.

A subsequent request is then received by embedded processor 110 to store a second object (OBJECT2). In response, embedded processor 110 determines whether or not BLOCK1 has sufficient residual memory space to store OBJECT2. If there is a sufficient residual memory space to store OBJECT2 in BLOCK1, embedded processor 110 does just that, thereby storing OBJECT1 and OBJECT2 in BLOCK1. If, however, BLOCK1 does not have sufficient residual memory space to store OBJECT2, embedded processor 110 defines a new memory block (e.g., BLOCK2) linked to BLOCK1 and stores OBJECT2 in BLOCK2.

Thus, each memory block is adapted to be allocated in relation to one or more objects, and is therefore able to store under certain object size conditions multiple object in an intra-memory block sequence. In other words, objects may be stored within a memory block in the pattern wherein each “next object” is allocated memory space within the current memory block without the need for creating a linked list (and corresponding point-chasing scheme), so long as sufficient memory space remains in the current memory block to store the requested object. Each memory block is operable within a larger dynamic point-chasing memory allocation scheme, being adapted for use within a linked list of memory blocks, each memory block containing additional information regarding the starting address for the next memory block.

By creating standard-sized, unit memory blocks capable of being both linked in a dynamic point-chasing scheme and divided in order to store multiple objects, the exemplary method dramatically improves the efficiency of memory allocation and de-allocation. This result is made possible by the reduced complexity of the memory allocation and de-allocation operations within the exemplary method. Operating speed is also enhanced because memory allocation and de-allocation operations for each object may be independently managed through only the memory block assigned to the object.

A unit memory block 310 may be structured, for example, to include a block header and plurality of objects allocated thereto. The block header may contain information identifying and/or defining the block, including in one embodiment; the number of stored objects (“object count”), the last address of the block (“last address”), an address indicating the location of residual (e.g., unused) memory space (“current address”), and a number and identity of objects previously removed from the block (“removed objects”).

The object count value represents the number of objects currently allocated for storage within the memory block. The last address value represents a last available address value (e.g., an “end” address) for the memory block. The current address value represents in one embodiment a last address value for a last object previously having been allocated in sequence to the memory block. The current address may thus be used as a potential starting address for a requested object. The removed object count indicates a number of objects previously de-allocated from the memory block.

Each object stored in the memory block may comprise an object header. The object header may comprise data representing the memory size of the object, and an object free flag representing an allocation/de-allocation status.

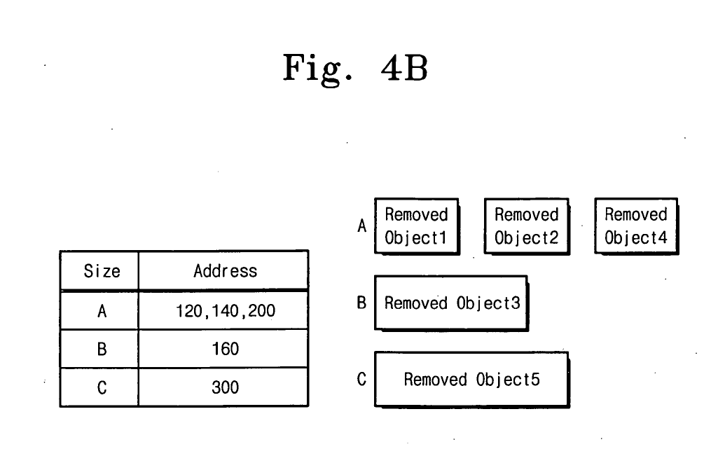

FIG. 4A is a schematic diagram illustrating a method for dynamic non-point-chasing memory de-allocation according to one embodiment of the invention.

Embedded processor 110 sets the object free flag to TRUE (assuming a binary TRUE/FALSE logic condition for the object free flag) and decreases the removed object count stored in the block header by one, when a request to de-allocate a currently stored object in BLOCK 310 is received during execution of a program stored in binary field 132. The dynamic non-point-chasing memory allocation scheme will remove an entire memory block only when a received de-allocation request removes all of (or the last of) the objects currently allocated in the memory block. Otherwise, memory block removal is not necessary when other de-allocation requests are received.

In other words, if the removed object count in a block header becomes 0, it means that a de-allocation request has removed all objects or the last object in the memory block. In this case, the entire memory space previously allocated to the memory block is de-allocated. As such, the dynamic non-point-chasing memory de-allocation scheme forming a portion of the exemplary method is different from pure dynamic point-chasing memory de-allocation schemes in the sense that most delays associated with the de-allocation of memory blocks are eliminated. According, the systemic performance is simplified and less power is consumed with the de-allocation of memory space.

FIGS. 4A and 4B collectively illustrate use of an object free list within a memory block. Embedded processor 110 constructs the free list from information (e.g., block size) derived from de-allocated objects. The free list forms a mechanism by which previously de-allocated memory space may be reused by the embedded system during a subsequent memory allocation request. In one embodiment, embedded processor 110 manages the free lists for the respective memory blocks. Each free list contains, for example, size and address values for the de-allocated objects. The free lists may be stored in data field 134 and/or stack 136. If an allocation request for an object having a size A is received during execution of a program stored in binary field 132, embedded processor 110 searches a reusable memory space associated with a previously de-allocated object using the free list(s). If the free list(s) indicate a de-allocated memory space having a size at least as large as A, it may be reused by the embedded system.

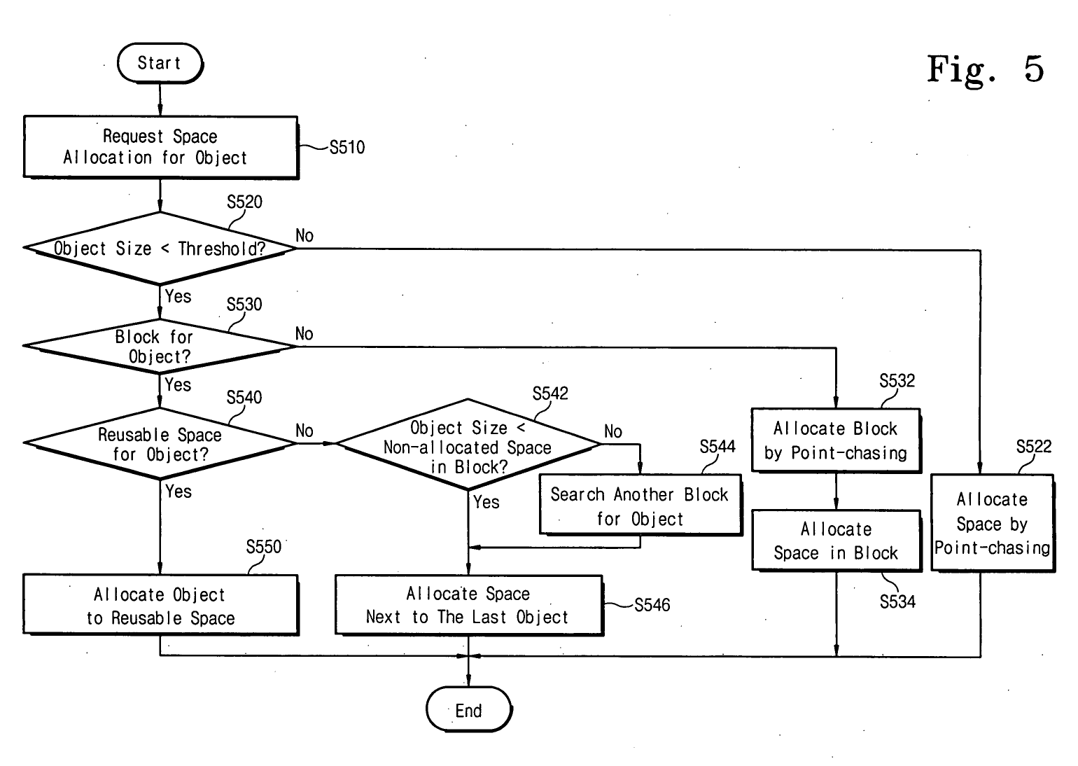

FIG. 5 is a flow chart illustrating a method implementing an exemplary variable dynamic memory allocation scheme in accordance with an embodiment of the invention. Exemplary method steps are indicated by the nomenclature (SXXX).

First, an allocation request is received in relation to a requested object (S510). A comparison is then made between the size of the requested object and a defined threshold value (S520). In this manner, the threshold value is used as a reference to determine whether the method will employ a point-chasing or non-point-chasing dynamic memory allocation scheme in relation to the requested object.

If the requested object size is smaller than the threshold value, the dynamic non-point-chasing memory allocation scheme is employed to enhance the efficiency of the memory management scheme. If the requested object size is larger than the threshold value, embedded processor 110 employs the dynamic point-chasing memory allocation scheme to allocate memory space for the storage of the requested object (S522). However, if the requested object size is smaller than the threshold value, embedded processor 110 employs the dynamic non-point-chasing memory allocation scheme to allocate memory space for the requested object.

This is done within the context of the illustrated example by first determining whether an existing memory block has sufficient residual memory space to store the requested object (S530). If there is not an existing memory block having sufficient residual memory space to store the requested object, embedded processor 110 defines a new memory block having a predetermined size using the dynamic point-chasing memory allocation scheme (S532), and then allocates memory space within the new memory block for the requested object according to its actual size using the dynamic non-point-chasing memory allocation scheme.(S534).

Otherwise, if an existing memory block having sufficient residual memory space to store the requested object is identified, embedded processor 110 next determines whether the identified memory block comprises reusable memory space of sufficient size to store the requested object (S540), (e.g., by consulting free list(s) associated with the identified memory block). Where sufficient reusable memory space is identified, it is allocated for and used to store the requested object (S550).

However, if no reusable memory space having sufficient size to store the requested object is identified, the requested object size is compared to non-allocated memory space for the identified memory block (S542). If the requested object size is larger than the non-allocated memory space, embedded processor 110 searches another memory block capable having sufficient non-allocated memory space (S544). Otherwise, the requested data object is allocated space beginning at the current address of the memory block (S546).

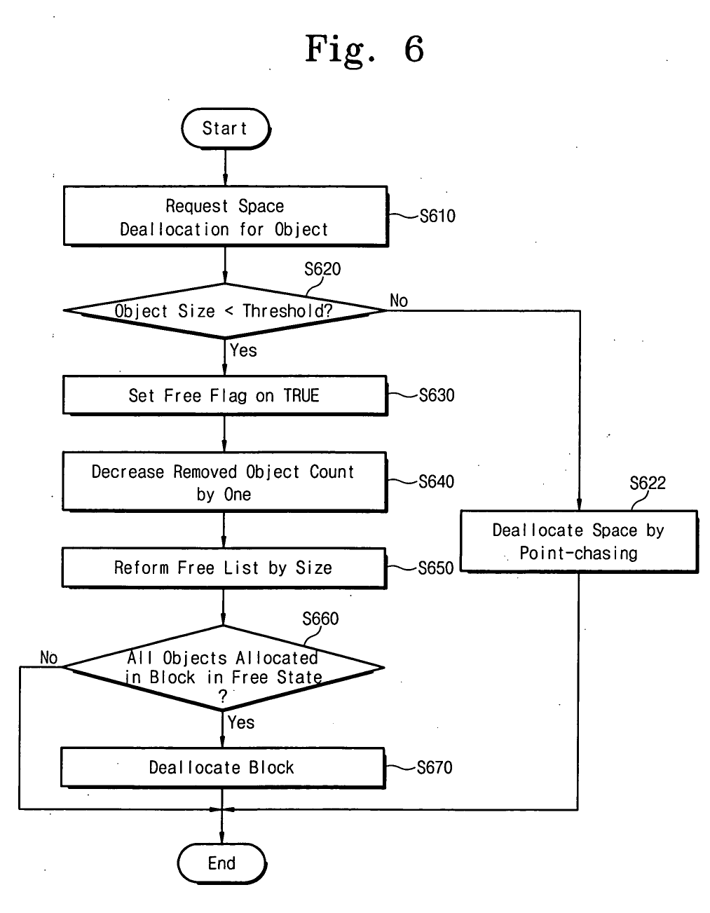

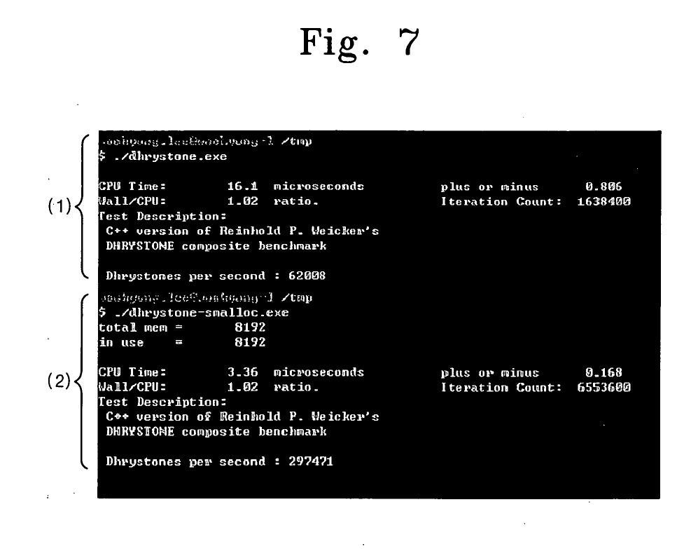

FIG. 6 is another flow chart illustrating a method implementing an exemplary variable dynamic memory de-allocation scheme in accordance with an embodiment of the invention.

A de-allocation request is received in relation to a requested object (i.e., the object to be removed from memory) (S610). Embedded processor 110 then compares the requested object size to the threshold value (S620). If the requested object size is larger than the threshold value, the dynamic point-chasing memory de-allocation scheme is employed to de-allocate memory space (S622). Otherwise, if the requested object size is smaller than the threshold value, embedded processor 110 defines a free object parameter within an object header associated with the requested object (e.g., sets a TRUE condition for a free flag) (S630), and decreases the removed object count in the block header by one (S640). Then, embedded processor 110 re-writes the free list(s) in relation to any entry(ies) associated with the requested object (S650). This enables the reuse of the memory space formerly associated with the requested object. Next, embedded processor 110 determines whether all objects allocated (or formerly allocated) memory space within the memory block are in a free state condition. If yes, the memory space associated with the constituent memory block is de-allocated (S670). Otherwise, the memory block is retained in memory, and the memory space associated with the free objects may be reused or put into a standby state.

FIG. 7 comparatively shows the performances of a conventional dynamic memory allocation scheme using only point-chasing with a variable dynamic memory allocation scheme alternatively using point-chasing and non-point-chasing schemes.

FIG. 7 results are derived from testing conducted using a Dhrystone program as a kind of benchmarking program which compares system operating speeds. A conventional 1.5 Ghz Pentium-IV based system was used having 1 GB of main memory. The Dhrystone program denotes as results a number of floating-point operations per second executed, as an approximation of system performance. Paragraph (1) of FIG. 7 shows results from execution of the Dhrystone program using the conventional point-chasing memory allocation scheme, and paragraph (2) shows results from execution of the Dhrystone program using the exemplary variable dynamic memory allocation scheme.

As can be seen from the test results, over four times as many floating-point operations were executed by the exemplary inventive method as compared with the conventional method. Thus, it can be appreciated that the system performance will be greatly improved by alternatively employing the dynamic point-chasing and non-point-chasing memory allocation schemes in relation to a referenced requested object size.

Within the context of the illustrated example, embedded processor 110 may serve as a main system controller or a memory controller additionally provided in a system to control subsidiary memory 120 and main memory 130.

Although the present invention has been described in connection with the several embodiment of the invention, it is not limited to only these embodiments. It will be apparent to those skilled in the art that various substitution, modifications and changes may be made thereto without departing from the scope of the invention, as defined by the following claims.

What is claimed is:

1. A method for dynamic memory management, comprising:
upon receiving an allocation request in relation to a requested object, comparing a requested object size to a threshold value;
allocating memory space using a point-chasing scheme when the requested object size is larger than the threshold value; else
allocating memory space using a non-point-chasing scheme.

2. The method of claim 1, wherein allocating memory space using a point-chasing scheme comprises forming a linked list of memory blocks.

3. The method of claim 1, wherein allocating memory space using a non-point-chasing scheme comprises:
searching an existing memory block to determine whether sufficient residual memory space exists to store the requested object, or
defining a new memory block to store the requested object.

4. The method of claim 3, wherein the new memory block is defined using a point-chasing scheme.

5. The method of claim 3, wherein upon determining that sufficient residual memory space exists to store the requested data object the method comprises:
identifying whether the existing memory block comprises reusable memory space sufficient to store the requested object, and if yes, storing the requested object in the reusable memory space.

6. The method of claim 5, wherein identifying whether the existing memory block comprises a reusable memory space sufficient to store the requested object comprises referencing one or more free lists.

7. The method of claim 5, wherein upon failing to identify reusable memory space sufficient to store the requested object, the method further comprises:
identifying whether the existing memory block comprises a non-allocated memory space sufficient to store the requested object.

8. The method of claim 7, wherein upon failing to identify a non-allocated memory space sufficient to store the requested object, the method further comprises:
searching another existing memory block.

9. The method of claim 7, wherein each memory block comprises a block header storing a current address, and wherein the method further comprises;
storing the requested object in the non-allocated memory space beginning at the current address.

10. A method for dynamic memory management, comprising:
upon receiving an de-allocation request in relation to a requested object, comparing a requested object size to a threshold value;
de-allocating memory space using a point-chasing scheme when the requested object size is larger than the threshold value; else
de-allocating memory space using a non-point-chasing scheme.

11. The method of claim 10, wherein de-allocating memory space using a point-chasing scheme comprises removing a memory block from a linked list of memory blocks.

12. The method of claim 10, wherein an existing memory block stores the requested object, the existing memory block comprises a block memory header storing a removed object value, and the requested object comprises an object header storing a free flag, and wherein allocating memory space using a non-point-chasing scheme comprises:
setting the free flag in the object header to indicate de-allocation of the requested object; and,
modifying the removed object count in the block memory header.

13. The method of claim 12, further comprising:
modifying one or more free lists associated with the requested object.

14. The method of claim 13, further comprising:
upon determining following modification of the removed object count that the existing block memory contains only objects indicating de-allocation, removing the existing memory block from a linked list of memory blocks using a point-chasing scheme.

15. An embedded system comprising:
an embedded processor adapted to control operation of the system;
a subsidiary memory adapted to store program files defining operation of the system; and
a main memory adapted to receive program files from the subsidiary memory, and further adapted to allocate memory space for a requested object using a dynamic point-chasing scheme or a non-point-chasing memory allocation scheme in accordance with the size of the requested object.

16. The embedded system of claim 15, wherein the embedded processor performs house-keeping operations for the system comprising; task scheduling, communications management between tasks, memory management, data input and output, and execution interruptions.

17. The embedded system of claim 15, wherein the main memory comprises:
a binary field configured to store an execution file received as a program file from the subsidiary memory;
a data field configured to store global variables related to the program file;
a stack adapted to store local variables related to the program file; and
a free space adapted to store objects related to the program file.

18. The embedded system of claim 17, wherein the free space is further configured to be allocated to store a requested object using the point-chasing scheme, such that a linked list of memory blocks is defined.

19. The embedded system of 18, wherein the free space is further configured to be allocated using the non-point-chasing scheme, such that the requested object is sequentially added to a memory block in non-allocated memory space.

20. The embedded system of 18, wherein the free space is further configured to be allocated using the non-point-chasing scheme, such that the requested object is added to a memory block in reusable memory space.

21. The embedded system of claim 15, the main memory is further adapted to de-allocate memory space for a requested object using the point-chasing or non-point-chasing schemes in accordance with the size of the requested object.

22. The embedded system of claim 21, wherein main memory is defined to comprise a plurality of memory block arranged in a linked list, wherein each one of the memory blocks comprises a header storing an object count, a current address, and a removed object count; and,
wherein the requested object comprises an object header storing a free flag and is stored in one of the plurality of memory blocks.

23. The embedded system of claim 22, wherein the embedded processor manages the main memory with reference to one or more free lists indicating a de-allocation for one or more objects.
